(19) United States
(12) Patent Application Publication
(10) Pub. No.: US 2010/0019467 A1
(43) Pub. Date: Jan. 28, 2010

(54) STEP SYSTEM FOR TRAILER ASSEMBLY

(76) Inventors: Edward R. Rowland, Alta Loma, CA (US); Thomas W. Hunsucker, Alta Lama, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/492,074

(22) Filed: Jun. 25, 2009

Related U.S. Application Data
(60) Provisional application No. 61/075,680, filed on Jun. 25, 2008.

(51) Int. Cl. B60R 3/00

(52) U.S. Cl. 280/163

(57) ABSTRACT

A boat trailer system includes a step that is cantilevered from a rearwardly-extending truss of the trailer's framework.

### REFERENCE TO PRIORITY DOCUMENT

This application claims priority of co-pending U.S. Provisional Patent Application Ser. No. 61/075,680, filed Jun. 25, 2008. Priority of the aforementioned filing date is hereby claimed and the disclosure of the Provisional Patent Application is hereby incorporated by reference in its entirety.

### BACKGROUND

The present disclosure relates to trailers. More particularly, the present disclosure relates to a step system for a boat trailer.

Trailers that are used to haul boats over land usually include a frame mounted on wheels and a tongue extending forwardly from the frame that connects to a hitch ball of the towing vehicle. There are occasions when a user of the boat trailer is often required to climb onto and around the frame of the boat trailer such as during loading or unloading of the boat.

In this regard, boat trailers may include one or more horizontal platforms that that the user can use as steps as the user maneuvers around the frame. The platforms are typically large and bulky and can be aesthetically unpleasing to the eye. The horizontal platforms can also be unwieldy and ill-suited for climbing and otherwise maneuvering around the boat frame. This is undesirable. Modern boat trailer owners desire an aesthetically pleasing boat and boat trailer and require a step system that is both safe to use and attractive.

In view of the foregoing, there is a need for improved step systems for boat trailers.

### SUMMARY

Disclosed is a trailer assembly, comprising a coupler arm having a front end and a rear end, the front end of the coupler arm configured for attachment to a towing vehicle; a support section extending rearwardly from the coupler arm and formed of a plurality of trusses including a rearwardly-extending truss at the rear of the support section; and a step attached to the rearwardly-extending truss of the support section wherein the step is cantilevered from the rearwardly-extending truss.

Other features and advantages should be apparent from the following description of various embodiments, which illustrate, by way of example, the principles of the disclosed devices and methods.

### BRIEF DESCRIPTION OF THE DRAWINGS

FIG. 1 shows a perspective view of a boat trailer.

FIG. 2 shows a perspective view of a step system of the boat trailer.

FIG. 3 shows the step system in an exploded state.

FIG. 4 shows a step partially mounted in a cavity of a truss of the boat trailer.

FIGS. 5 and 6 show additional views of the step.

### DETAILED DESCRIPTION

Before the present subject matter is further described, it is to be understood that this subject matter described herein is not limited to particular embodiments described, as such may of course vary. It is also to be understood that the terminology used here in is for the purpose of describing particular embodiments only, and is not intended to be limiting. Unless defined otherwise, all technical terms used herein have the same meaning as commonly understood by one skilled in the art to which this subject matter belongs.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible

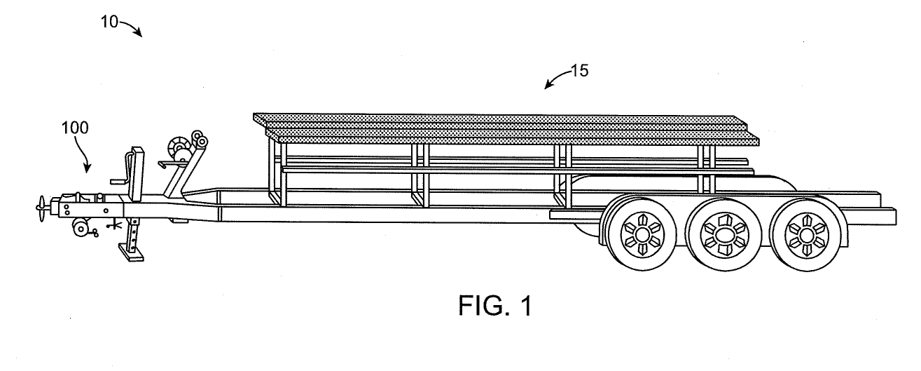

FIG. 1 shows a perspective view of a trailer such as a boat trailer 10 having a support section 15 configured to provide support to a boat or other load in a well-known manner. The boat trailer 10 optionally includes a pivoting coupler assembly 100 for coupling the trailer 10 to a towing vehicle. With reference to FIG. 1, at least a portion of the boat trailer 100 is comprised of a plurality of interconnected trusses that collectively form a framework structure that forms the trailer 100.

For clarity of illustration, the structural details of the coupler assembly 100 are not shown in FIG. 1. Although described herein in the context of a boat trailer, it should be appreciated that the coupler assembly described herein can be used with other types of trailers that are towed. It should also be appreciated that the structure and shape of the trailer is not limited to that shown in FIG. 1.

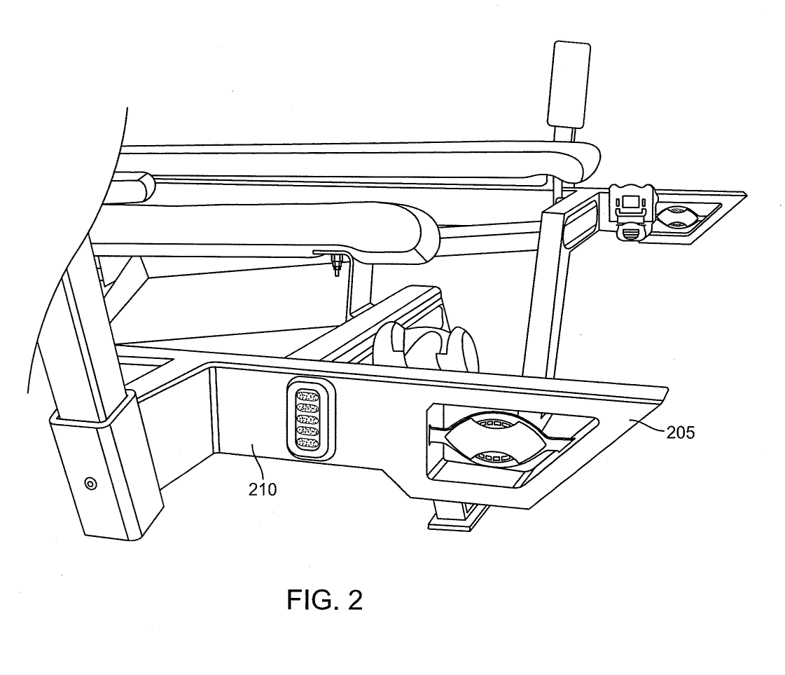

The trailer includes a step system located on a rear or tail end of the trailer. The step system comprises a step that is cantilevered from a rear portion of the trailer. In an embodiment, the step system is cantilevered off of a rearwardly-extending beam or truss of the trailer wherein the rearwardly extending beam is parallel to a longitudinal axis of the boat trailer. In another embodiment, the step system is cantilevered off of a beam or truss that is cross-wise or otherwise intersects that longitudinal axis of the boat trailer. FIG. 2 shows a perspective view of the step system, which is comprised of a step 205 that extends rearwardly from a rearwardly-extending truss 210 of the trailer. As described below, the step 205 is mounted within a cavity of the truss 210 and attached thereto. The means of attachment can vary and can include a weld, bolts, glue, etc.

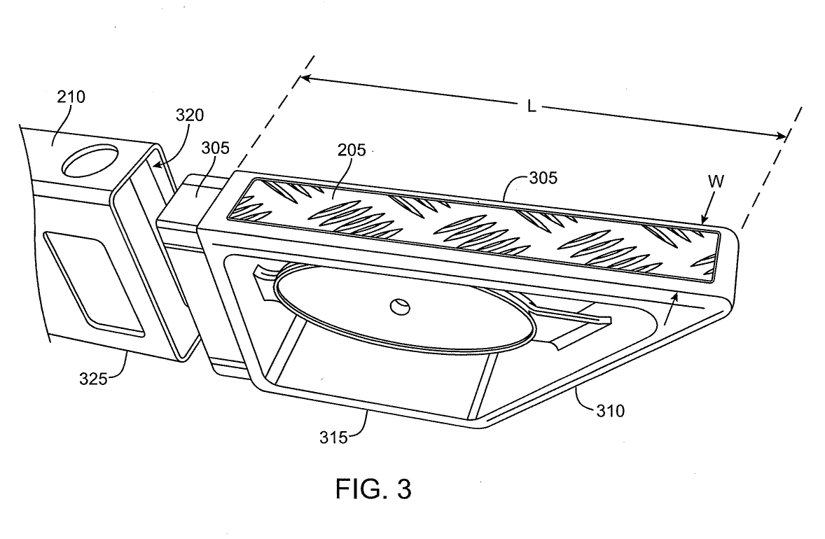

The step can be shaped in a variety of manners. With reference to FIGS. 2 and 3, in an embodiment the step has a horizontal top surface 305 that serves as a step for an individual that mounts the trailer. An inclined bottom surface 310 is angled downward and extends toward a horizontal bottom surface 315. This provides the step with a partially triangular or “shark-fin” shape. It should be appreciated that the shape of the step can vary. In the illustrated embodiment, the step 305 has a width W that is significantly less than the steps maximum length. For example, the width may be approximately two units of length while the length is ten units of length such that the length is at least five times the width.

FIG. 3 shows the step system in an exploded state. The truss 210 has a cavity 320 that is sized to receive a rear front portion 305 of the step 205. In this regard, the front portion 305 is sized to fit inside the cavity. In an embodiment, the front portion 305 steps down in size from the remainder of the step 205 to provide a flush, seamless like appearance when the step 205 is mounted in the beam, as shown in the assembled state of FIG. 2. The truss 210 can have an opening 325 to permit access to the front portion 305 of the step 205 when it is mounted in the truss 210 or to mount a device such as a light or reflector.

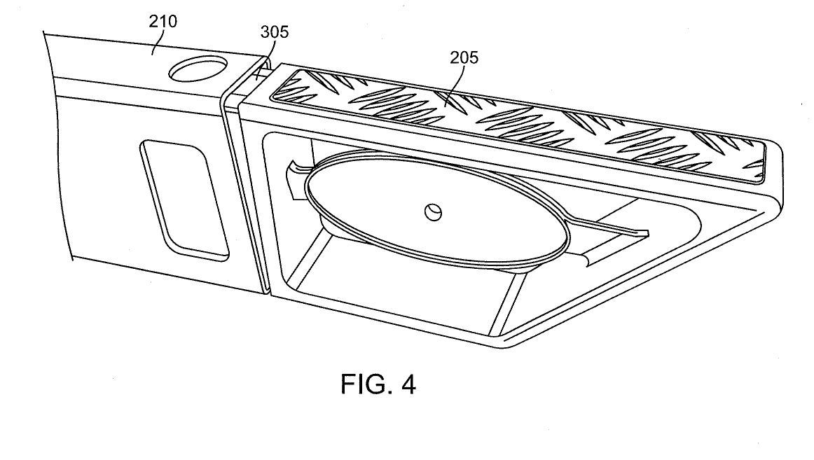

FIG. 4 shows the step 205 partially mounted in the cavity 320 of the truss 210. Note that the front portion 305 of the step 205 can be fully inserted into the truss 210 to provide a flush segue between the outer surfaces of the step 205 and the truss 210.

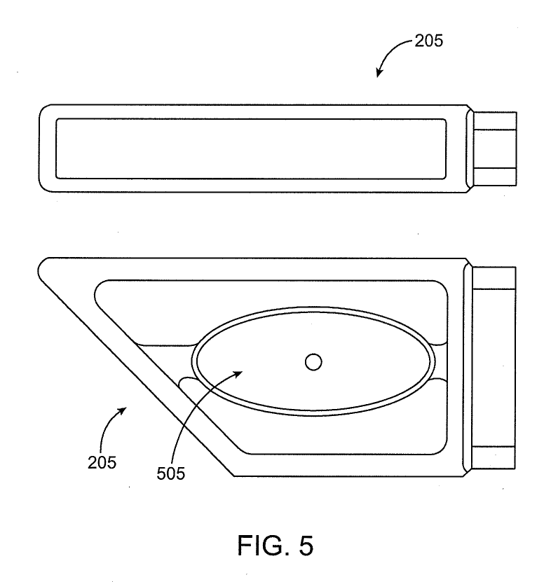

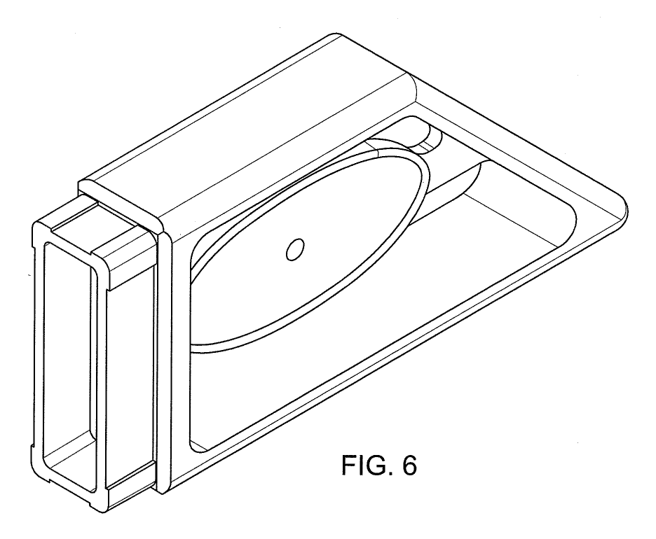

FIGS. 5-6 show additional, detailed views of the step 205. FIG. 5 shows side and top view of the step 205. When viewed from the side, the step 205 has a shape such that an upper, distal edge is pointed. The flat upper surface of the step is horizontal with an inclined bottom surface that inclines downwardly from the point of the upper surface. The inclined bottom surface transitions to a horizontal bottom surface. A middle region 505 of the step 205 can include a region where a logo or other graphic can be displayed. The flat upper surface of the step 205 can include a region where a plate or other insert can be positioned. The insert can be manufactured of a material that provides a friction surface to prevent a person's foot from slipping or sliding when positioned on the step.

The step can be formed of various materials. In an embodiment, it is formed of steel. In an embodiment, the step is manufactured using a molding or a casting process. Once installed, the step 205 provides an area to step onto when climbing into a boat mounted on the trailer. The step 205 also acts as a cap for the end of the truss 210 and provides a place for a company logo or placard.

A number of embodiments have been described. Nevertheless, it will be understood that various modifications may be made without departing from the spirit and scope of the claims. Accordingly, other embodiments are within the scope of the following claims.

1. A trailer assembly, comprising:
a coupler arm having a front end and a rear end, the front end of the coupler arm configured for attachment to a towing vehicle, wherein the trailer assembly has a longitudinal axis;
a support section extending rearwardly from the coupler arm and formed of a plurality of trusses including a rearwardly-extending truss at the rear of the support section, wherein the rearwardly-extending truss is parallel to the longitudinal axis of the trailer assembly;
a step attached to the rearwardly-extending truss of the support section.

2. A trailer assembly as in claim 1, wherein the step is cantilevered from the rearwardly-extending truss.

3. A trailer assembly as in claim 1, wherein the rearwardly-extending truss has a cavity and wherein the step is at least partially mounted inside the cavity.

4. A trailer assembly as in claim 3, wherein the step has a front portion that fits within the cavity of the truss.
